(19) United States
(12) Patent Application Publication
(10) Pub. No.: US 2022/0037636 A1
(43) Pub. Date: Feb. 3, 2022

(54) LITHIUM-MANGANESE DIOXIDE PRIMARY BATTARY AND PREPARATION THEREOF

(71) Applicant: Long Power Systems (Nantong) Co.,Ltd., Nantong (CN)

(72) Inventors: Biying HUANG, Nantong (CN); Richard Brian HUANG, Nantong (CN); Tianwen TANG, Nantong (CN)

(21) Appl. No.: 17/501,563

(22) Filed: Oct. 14, 2021

(30) Foreign Application Priority Data
Oct. 15, 2020 (CN) 202011102283.2

(51) Int. Cl. H01M 4/08; H01M 4/04; H01M 4/587; H01M 4/50; H01M 4/36; H01M 4/62; H01M 4/38; H01M 4/66; H01M 4/74; H01M 6/16; H01M 50/403; H01M 50/434; H01M 50/449; H01M 50/103

(52) U.S. Cl. CPC H01M 4/08; H01M 50/103; H01M 4/0471; H01M 4/0435; H01M 4/587; H01M 4/502; H01M 4/366; H01M 4/625; H01M 4/382; H01M 4/661; H01M 4/74; H01M 6/164; H01M 50/403; H01M 50/434; H01M 50/449; H01M 4/0404

(57) ABSTRACT

A lithium-manganese dioxide primary battery and preparation thereof. The battery has a discharge capacity greater than 3C at −40° C., and includes multiple positive plates, multiple negative plates, multiple ceramic separators, an electrolyte and a casing. The positive plates, the negative plates and the separators are laminated in a manner of repeated “positive plate-separator-negative plate-separator” to form a dry cell. The lithium-manganese dioxide primary battery is made by placement of the dry cell into the casing, injection of the electrolyte, primary aging, sealing and secondary aging. The positive plate and the negative plate are graphene-based manganese dioxide positive plate and lithium-carbon composite negative plate, respectively. The front and back surfaces of the positive plate are respectively provided with a positive reserved tab, and the front and back surfaces of the negative plate are respectively provided with a negative reserved tab.

### CROSS-REFERENCE TO RELATED APPLICATIONS

This application claims the benefit of priority from Chinese Patent Application No. 202011102283.2, filed on Oct. 15, 2020. The content of the aforementioned application, including any intervening amendments thereto, is incorporated herein by reference in its entirety.

### TECHNICAL FIELD

The present disclosure relates to high-capacity primary lithium batteries, in particular to a lithium-manganese dioxide (Li—MnO₂) primary battery and a preparation method thereof.

### BACKGROUND

Lithium manganese batteries are becoming more and more popular due to their advantages of high operating voltage and energy density, low self-discharge rate and superior storage performance. However, the lithium manganese battery is not suitable for those facilities used at a low temperature (−40° C.), such as some power electronic digital products, special exploration apparatuses, starting power supplies and military equipment power supplies, due to the difficulty in meeting the demand for high current discharge, especially in meeting the performance requirements at a discharge rate above 3C.

Improving the discharge performance is the key to achieving the high-rate discharge of the lithium manganese battery in a low-temperature environment, and the discharge performance generally depends on the following factors.

### (1) Positive Electrode Material

At present, the commonly-used positive active material is electrolytic manganese dioxide; however, the electrolytic manganese dioxide fails to meet the high-rate discharge requirements in low-temperature environments. Moreover, during the manufacturing process of the positive electrode, the paste-like electrolytic manganese dioxide is generally selected and applied on the current collector to form a positive plate. In this case, the coating has relatively poor compactness, and the contact between the manganese dioxide particles and the current collector is not sufficient, which leads to an increase in the internal resistance, weakening the discharge performance of the primary lithium manganese battery.

### (2) Negative Electrode Material

In the prior art, a metal lithium strip is commonly used as the negative active material, but it also struggles with the following defects. On one hand, the metal lithium strip is relatively soft so that it is prone to wrinkling and cracking when subjected to external forces. On the other hand, the metal lithium strip is chemically active, so that it is easy to react with water in the environment during the preparation, resulting in a reduction in the electrochemical performance of the processed negative plate.

### (3) Electrolyte

The existing electrolyte has low compatibility with the primary lithium manganese battery in a low temperature environment, which leads to the poor fluidity of electrolyte inside the primary lithium manganese battery, and reduces the mobility of Li⁺ in the electrolyte, thereby affecting the ion conductivity and electron transfer rate of the primary lithium manganese battery under the low-temperature environment.

### (4) Connection between Positive and Negative Plates and External Current Collector

In the prior art, the positive plate and the negative plate are generally welded to the external current collector through an external tab lead, which makes the internal resistance of the primary lithium manganese battery relatively high.

In addition, the quality of the primary lithium manganese battery is closely related to the preparation environment, and the high-rate discharge performance in a low temperature environment raises higher requirements for the quality of the primary lithium manganese battery. In the preparation of a negative plate of a traditional primary lithium manganese battery, when the chemically-active metal lithium strips are used as negative electrode materials, the operating environment and the processing environment should be strictly controlled, which leads to an increase in the production cost.

### SUMMARY

The purpose of the present disclosure is to provide a lithium-manganese dioxide primary battery and a preparation method thereof to overcome the technical problems in the prior art.

Technical solutions of the disclosure are described as follows.

In a first, the present disclosure provides a lithium-manganese dioxide primary battery, comprising:

a dry cell;

an electrolyte; and

a casing;

wherein the dry cell comprises a plurality of positive plates, a plurality of negative plates and a plurality of separators; the plurality of positive plates, the plurality of negative plates and the plurality of separators are laminated in a manner of repeated “positive plate-separator-negative plate-separator”; the lithium-manganese dioxide primary battery is prepared by placement of the dry cell in the casing, injection of the electrolyte, primary aging, sealing and secondary aging; each of the plurality of positive plates is a graphene-based manganese dioxide positive plate; each of the plurality of negative plates is a lithium-carbon composite negative plate; both surfaces of each of the plurality of positive plates are provided with a positive reserved tab, respectively; both surfaces of each of the plurality of negative plates are provided with a negative reserved tab, respectively; and the lithium-manganese dioxide primary battery has a discharge capacity equal to or larger than 3C at −40° C.;

the dry cell is provided with a positive tab and a negative tab; positive reserved tabs of the plurality of positive plates are aligned with each other and welded with a first flat metal sheet current collector to form the positive tab; negative reserved tabs of the plurality of negative plates are aligned with each other and welded with a second flat metal sheet current collector to form the negative tab;

each of the plurality of ceramic separators is a nanoporous ceramic separator;

the electrolyte is made by mixing 0.7-2 mol of a lithium salt with an organic solvent, wherein the organic solvent is carbonate or carboxylate; and

the positive tab and the negative tab are respectively provided at both ends of the casing to respectively serve as a positive current collector and a negative current collector

In an embodiment, the lithium salt is selected from the group consisting of lithium perchlorate, lithium hexafluorophosphate, lithium tetrafluoroborate, lithium bis(oxalate) borate, lithium oxalyldifluoroborate, lithium bis(fluorosulfonyl)imide, lithium (trifluoromethanesulfonyl)imide, lithium trifluoromethansulfonate and lithium iodide;

the carbonate is selected from the group consisting of dimethyl carbonate, ethyl methyl carbonate and diethyl carbonate; and

the carboxylate is selected from the group consisting of methyl formate, methyl acetate, ethyl acetate, propyl acetate, methyl propionate, methyl butyrate and ethyl butyrate.

In an embodiment, the casing is square, and is made of steel, aluminum or an aluminum-plastic material.

In a second aspect, the present disclosure provides a method for preparing the lithium-manganese dioxide primary battery, comprising:

(S1) Preparation of Graphene-Based Manganese Dioxide Positive Plate

mixing 85%-98% by weight of graphene-based manganese dioxide, 1%-10% by weight of a first conductive agent and 1%-15% by weight of a first binder to prepare a cathode active paste; evenly coating the cathode active paste on both surfaces of an aluminum mesh current collector using a coating machine to form a cathode coating, wherein a cathode blank area is reserved between four edges of the cathode coating and four edges of the aluminum mesh current collector; dividing the cathode blank area into the positive reserved tab, a cathode polymeric adhesive area and two cathode insulating tape areas, wherein the positive reserved tab and the cathode polymeric adhesive area are respectively located at both ends of the cathode coating, and the two cathode insulating tape areas are respectively located at both sides of the cathode coating; drying the aluminum mesh current collector coated with the cathode coating at 85° C. in a vacuum drying oven; calendering the cathode coating to a surface density of 50-100 mg/cm² using a calender; dipping the two cathode insulating tape areas in a first polymeric adhesive such that the two cathode insulating tape areas are covered with the first polymeric adhesive; and drying the aluminum mesh current collector coated with the cathode coating at 110° C. in the vacuum drying oven to obtain the graphene-based manganese dioxide positive plate with a moisture content of less than 30 ppb;

(S2) Preparation of Lithium Carbon Composite Negative Plate

mixing 85%-98% by weight of a lithium-carbon composite material, 1%-10% by weight of a second conductive agent and 1%-15% by weight of a second binder to produce an anode active paste; evenly coating the anode active paste on both surfaces of a copper mesh current collector using the coating machine to form an anode coating, wherein an anode blank area is reserved between four edges of the anode coating and four edges of the copper mesh current collector; dividing the anode blank area into the negative reserved tab, an anode polymeric adhesive area and two anode insulating tape areas, wherein the negative reserved tab and the anode polymeric adhesive area are respectively located at both ends of the anode coating, and the two anode insulating tape areas are respectively located at both sides of the anode coating; drying the copper mesh current collector coated with the anode coating at 85° C. in a vacuum drying oven; calendering the anode coating to a surface density of 25-50 mg/cm² using the calender; dipping the two anode insulating tape areas in a second polymeric adhesive such that the two anode insulating tape areas are covered with the second polymeric adhesive; and drying the copper mesh current collector coated with the anode coating at 110° C. in the vacuum drying oven to obtain the lithium-carbon composite negative plate with a moisture content of less than 30 ppb;

(S3) Preparation of Nanoporous Ceramic Separator coating front and back surfaces of an ordinary ceramic separator respectively with a nano-alumina coating followed by drying in the vacuum drying oven to remove solvent in the nano-alumina coating to obtain the nanoporous ceramic separator, wherein the nanoporous ceramic separator has a thickness of 6-40 μm, and an area of the nanoporous ceramic separator is larger than an area of the graphene-based manganese dioxide positive plate or the lithium-carbon composite negative plate;

(S4) Preparations of Dry Cell

laminating a plurality of graphene-based manganese dioxide positive plates obtained from step (S1), a plurality of lithium-carbon composite negative plates obtained from step (S2) and a plurality of nanoporous ceramic separators obtained from step (S3) in a manner of repeated “graphene-based manganese dioxide positive plate-nanoporous ceramic separator-lithium-carbon composite negative plate-nanoporous ceramic separator” to form the dry cell, wherein during the laminating process, the two cathode insulating tape areas of each of the plurality of graphene-based manganese dioxide positive plates are wrapped with a first insulating tape, and the two anode insulating tape areas of each of the plurality of lithium-carbon composite negative plates are wrapped with a second insulating tape; first reserved tabs of the plurality of graphene-based manganese dioxide positive plates are laminated, aligned with each other and welded with the first flat metal sheet current collector to form the positive tab; and second reserved tabs of the plurality of lithium-carbon composite negative plates are laminated, aligned with each other and welded with the second flat metal sheet current collector to form the negative tab; and

(S5) Battery Assembly

placing the dry cell into the casing at a preset temperature and a preset pressure, wherein the positive tab and the negative tab respectively serve as the positive current collector and the negative current collector; and injecting the electrolyte followed by primary aging, sealing and secondary aging to produce the lithium-manganese dioxide primary battery.

In an embodiment, the graphene-based manganese dioxide is prepared by coating surfaces of manganese dioxide particles with graphene nanoparticles; and the graphene-based manganese dioxide is dried in the vacuum drying oven at 375-400° C. before use.

In an embodiment, the lithium-carbon composite material is prepared through steps of: adding metal lithium to an organic solvent for liquid-phase buoyancy dispersion; and adding carbon powder to the organic solvent such that with volatilization of the organic solvent, the carbon powder settles from vaporized organic solvent to coat the metal lithium to form the lithium-carbon composite material; and the lithium-carbon composite material is dried in the vacuum drying oven at 100-120° C. before use.

In an embodiment, the coating machine and the vacuum drying oven both have a vacuum internal environment with a pressure of −0.08 to −0.1 MPa; and a pressure of an external environment of the coating machine and the vacuum drying oven is standard atmospheric pressure.

In an embodiment, the aluminum mesh current collector is an aluminum mesh sheet with a thickness of 10-25 μm; and the copper mesh current collector is a copper mesh sheet with a thickness of 6-20 μm.

In an embodiment, the first conductive agent and the second conductive agent are independently selected from the group consisting of superconducting carbon black, conductive graphite, carbon fiber, carbon nanotube, graphene and a combination thereof; and the first binder and the second binder are independently selected from the group consisting of polyvinylidene fluoride (PVDF), styrene butadiene rubber, sodium carboxymethyl cellulose and a combination thereof.

In an embodiment, the first insulating tape comprises a first substrate and a first adhesive layer; the second insulating tape comprises a second substrate and a second adhesive layer; the first substrate and the second substrate are independently selected from the group consisting of polyimide, polysulfone, polyphenylene sulfide, polyetherketone and a combination thereof; the first adhesive layer and the second adhesive layer are both silica gel; the first insulating tape and the second insulating tape both have a thickness of 10-60 μm and are capable of withstanding a temperature greater than 200° C.; and the first polymeric adhesive and the second polymeric adhesive are independently selected from the group consisting of PVDF, polyacrylonitrile (PAN) and a combination thereof.

Compared to the prior art, this application has the following beneficial effects.

(1) This application optimizes the cathode material by replacing the traditional electrolytic manganese dioxide with graphene-based manganese dioxide.

Since the graphene has the advantages of stable structure, large specific surface area, small particle size (nano) and high electronic conductivity, when the grapheme nanoparticle-coated manganese oxide is used as the cathode active material, the electronic conductivity is enhanced, thereby improving the high-rate discharge performance of the battery in a low-temperature environment.

(2) The preparation of the manganese dioxide positive plate is optimized herein. Specifically, the cathode active paste is uniformly coated on the aluminum mesh current collector, dried and rolled, which not only improves the compactness of the cathode coating on the current collector, but also increases the contact area between the cathode active material and the current collector, reducing the internal resistance and enhancing the discharge performance of the battery.

(3) This application optimizes the anode material by replacing the metal lithium strip with the lithium-carbon composite material. Compared to the metal lithium strip, the lithium-carbon composite material has higher chemical stability, which facilitates reducing the lithium loss during the preparation process, improving the electrochemical performance of the anode material and effectively maximizing the utilization of the anode material in the cell.

(4) This application optimizes the preparation of the negative plate. Specifically, different from the traditional metal lithium negative plate, the disclosure prepares an anode active paste by mixing the lithium-carbon composite material, the conductive agent and the binder, and then uniformly applies the anode active paste onto the copper mesh current collector, which improves the electrical conductivity of the negative plate. In addition, this disclosure employs the lithium-carbon composite material as the anode active material. Compared to the metal lithium strip, the lithium-carbon composite material has higher hardness. In the preparation process, the anode active paste is uniformly coated on the copper mesh current collector, dried and rolled, which not only improves the compactness of the anode coating, but also increases the contact area between the negative active material and the copper mesh current collector, reducing the internal resistance, and improving the discharge performance of the lithium manganese primary battery.

(5) This application further optimizes the composition of the electrolyte. Specifically, a lithium salt is mixed with an organic solvent with low viscosity and low melting point (such as carboxylate and carbonate) to produce the electrolyte, which effectively reduces the viscosity and improves the fluidity of the electrolyte in the primary lithium manganese battery. Moreover, the inertness of Li⁺ in the electrode active material and the electrolyte at a low temperature is eliminated and the mobility of Li⁺ is enhanced, thereby improving the ion conductivity and electron transmission rate of the lithium-manganese dioxide primary battery in a low-temperature environment.

(6) This application employs a nanoporous ceramic with high porosity and high wettability in a low temperature environment as the separator. The nano-alumina coating not only effectively increases the melting point of the nanoporous ceramic separator, strengthens the surface hardness of the nanoporous ceramic separator and effectively prevents the separator from being pierced by the active material with large hardness and burrs, but also improves the affinity of the nanoporous ceramic separator to the electrolyte. At the same time, the high porosity allows more Li⁺ to enter the electrolyte from the negative electrode, migrate, and transport to the positive electrode at a larger rate, thereby improving the ionic conductivity of the lithium manganese primary battery in a low temperature environment.

(7) In the preparation of the dry cell, the positive reserved tabs/negative reserved tabs are laminated together and welded to form the positive tab/negative tab. Compared to the prior art in which an external tab is introduced by welding, the design provided herein effectively reduces the internal resistance, improves the conductivity, and enhances the discharge voltage plateau and discharge rate of the battery, thereby improving the high-rate discharge performance in a low-temperature environment.

(8) Since the lithium-carbon composite material is less active with respect to the metal lithium strip, it is only required to maintain a vacuum environment inside the coating machine and the vacuum drying oven during the preparation process. Moreover, there are no special requirements for the outside environment of these devices, facilitating the manual operation and lowering the production cost.

### BRIEF DESCRIPTION OF THE DRAWINGS

FIG. 1 is a cross-sectional view of an aluminum mesh current collector according to an embodiment of the present disclosure.

FIG. 2 is a cross-sectional view of a copper mesh current collector according to an embodiment of the present disclosure.

FIG. 3 is a sectional view of the laminated structure of the dry cell according to an embodiment of the present disclosure.

FIG. 4 is a schematic diagram of an insulating tape according to an embodiment of the present disclosure.

FIG. 5 schematically shows structure of a side surface of the lithium-manganese dioxide primary battery according to an embodiment of the present disclosure.

FIG. 6 shows comparison of discharge performance of the lithium-manganese dioxide primary battery according to an embodiment of the present disclosure and a traditional lithium-manganese dioxide battery at −40° C./3C.

### DETAILED DESCRIPTION OF EMBODIMENTS

In order to deepen the understanding of technical solutions of the present disclosure, the disclosure will be further described in detail below with reference to embodiments and accompanying drawings. It should be noted that these embodiments are only illustrative of the disclosure, and are not intended to limit the disclosure.

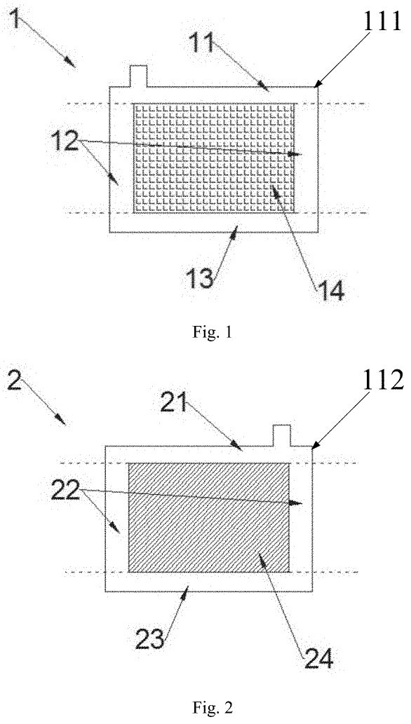

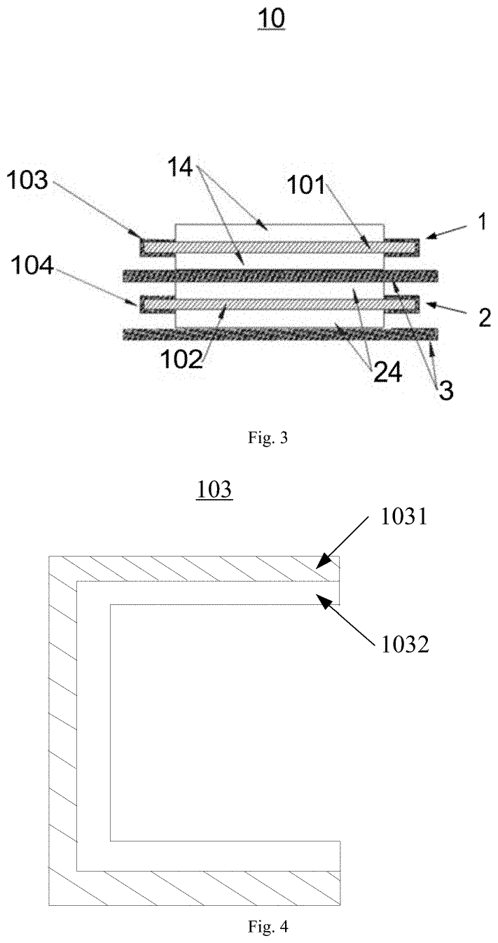

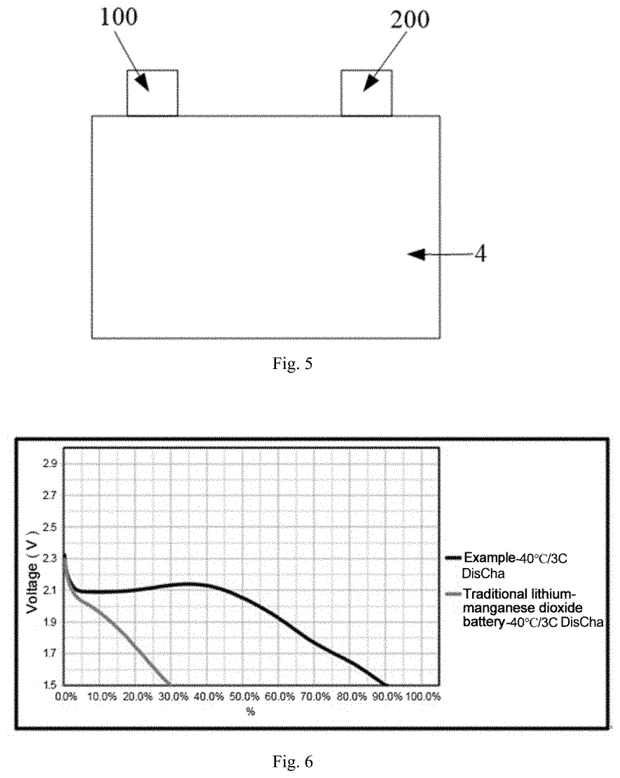

As shown in FIGS. 1-3 and 5, the disclosure provides a low-temperature and high-capacity lithium-manganese dioxide battery primary, which has a discharge rate greater than 3C at −40° C. The battery includes a dry cell 10, an electrolyte and a casing 4. The dry cell 10 includes a plurality of positive plates 1, a plurality of negative plates 2 and a plurality of ceramic separators 3. The positive plates 1, the negative plates 2 and the ceramic separators 3 are laminated in a manner of repeated “positive plate-ceramic separator-negative plate-ceramic separator”. The lithium-manganese dioxide primary battery is made by placement of the dry cell 10 into the casing 4, injection of the electrolyte, primary aging, sealing and secondary aging. The positive plate 1 is a graphene-based manganese dioxide positive plate, and the negative plate 2 is a lithium-carbon composite negative plate. Front and back surfaces of the positive plate 1 are respectively provided with a positive reserved tab 11, and front and back surfaces of the negative plate 2 is provided with a negative reserved tab 21.

The dry cell 10 includes a positive tab 100 and a negative tab 200. When the positive plates 1 are laminated, the positive reserved tabs 11 are aligned with each other and welded with a first flat metal sheet current collector to form the positive tab 100. When the negative plates 2 are laminated, the negative reserved tabs 21 are aligned with each other and welded with a second flat metal sheet current collector to form the negative tab 200.

The ceramic separator 3 is a nanoporous ceramic separator with high porosity and high wettability in a low temperature environment.

The electrolyte is made by mixing 0.7-2 mol of a lithium salt with an organic solvent with low viscosity and low melting point, where the organic solvent is carbonate or carboxylate.

The two ends of the casing 4 are respectively provided with a cathode current collector and an anode current collector. In the disclosure, the cathode current collector is the positive tab 100, and the anode current collector is the negative tab 200. After the dry cell 10 is placed into the casing 4, the positive tab 100 and the negative full tab 200 extending out of the casing 4 serve as the cathode current collector 41 and the anode current collector 42, respectively.

In an embodiment, the lithium salt is selected from the group consisting of lithium perchlorate, lithium hexafluorophosphate, lithium tetrafluoroborate, lithium bis(oxalate) borate, lithium oxalyldifluoroborate, lithium bis(fluorosulfonyl)imide, lithium (trifluoromethanesulfonyl)imide, lithium trifluoromethanesulfonate and lithium iodide.

In an embodiment, the carbonate is selected from the group consisting of dimethyl carbonate, ethyl methyl carbonate, and diethyl carbonate.

In an embodiment, the carboxylate is selected from the group consisting of methyl formate, methyl acetate, ethyl acetate, propyl acetate, methyl propionate, methyl butyrate and ethyl butyrate.

In an embodiment, the casing 4 is square, and is made of steel, aluminum or an aluminum-plastic material.

Referring to FIGS. 1-5, this application provides a method of preparing a low temperature-resistant and high-capacity lithium-manganese dioxide primary battery, which specifically includes the following steps.

### (S1) Preparation of Graphene-Based Manganese Dioxide Positive Plate

85%-98% by weight of graphene-based manganese dioxide, 1%-10% by weight of a first conductive agent and 1%-15% by weight of a first binder are mixed to produce a cathode active paste. Then the cathode active paste is evenly coated on the front and back surfaces of the aluminum mesh current collector 101 by the coating machine to form a cathode coating 14. A cathode blank area 111 is reserved between the four edges of the cathode coating 14 and the four edges of the aluminum mesh current collector 101, and is divided into the positive reserved tab 11, the cathode polymeric adhesive area 13 and two cathode insulating tape areas 12. The cathode reserved tab 11 and the cathode polymeric adhesive area 13 are respectively located at both ends of the cathode coating 14, and the two cathode insulating tape areas 12 are respectively located on both sides of the cathode coating 14. The above-mentioned two ends are the upper and lower ends, and the two sides are the left and right sides of the cathode coating 14. The aluminum mesh current collector 101 coated with the cathode coating 14 is dried at 85° C. in a vacuum drying oven, and rolled with a calender to make the cathode coating 14 have a surface density of 50 to 100 mg/cm². The cathode insulating tape area 12 is dipped in a first polymeric adhesive to be wrapped, and then the whole aluminum mesh current collector 101 is dried at 110° C. in the vacuum drying oven to obtain the graphene-based manganese dioxide positive plate with water content of less than 30 ppb.

### (S2) Preparation of Lithium-Carbon Composite Negative Plate

85%-98% by weight of a lithium-carbon composite material, 1%-10% by weight of a second conductive agent and 1%-15% by weight of a second binder are mixed to produce an anode active paste. Then the anode active paste is evenly coated on the front and back sides of the copper mesh current collector 102 by the coating machine form an anode coating 24. An anode blank area 112 is reserved between four edges of the anode coating 24 and the four edges of the copper mesh current collector 102, and is divided into the negative reserved tab 21, the anode polymeric adhesive area 23 and two cathode insulating tape areas 22. The negative reserved tab 21 and the anode polymeric adhesive area 23 are respectively located at both ends of the anode coating 24, and the two anode insulation tape areas 22 are located on both sides of the anode coating 24. The copper mesh current collector 102 coated with the anode coating 24 is dried at 85° C. in a vacuum drying oven, and rolled with a calender to make the anode coating 24 have a surface density of 25 to 50 mg/cm². The anode insulating tape area is dipped in a second polymeric adhesive to be wrapped, and then the whole copper mesh current collector 102 is dried at 110° C. in the vacuum drying oven to obtain the lithium-carbon composite negative plate with a water content of less than 30 ppb.

### (S3) Preparation of Nanoporous Ceramic Separator

The front and back surfaces of an ordinary ceramic separator are respectively coated with a nano-alumina coating, and then dried in the vacuum drying oven to remove the solvent in the alumina coating to obtain the nanoporous ceramic separator with high porosity and high wettability in a low temperature environment, where the thickness of the nanoporous ceramic separator is 6-40 μm, and the area of the nanoporous ceramic separator is larger than that of the graphene-based manganese dioxide positive plate or the lithium-carbon composite negative plate.

### (S4) Preparation of Dry Cell

The graphene-based manganese dioxide positive plates and the lithium-carbon composite negative plates are alternately laminated to form a dry cell 10, where the graphene-based manganese dioxide positive plate is separated from the adjacent lithium-carbon composite negative plate by the nano-porous ceramic separator.

During the lamination process, the cathode insulating tape area 12 is covered with a first high-temperature insulating tape 103, and the anode insulating tape area 22 is covered with a second high-temperature insulating tape 104. The positive reserved tabs 11 are laminated together and welded with a flat metal sheet current collector to form a positive tab 100, and the negative reserved tabs 21 are laminated together and welded with another flat metal sheet current collector to form a negative tab 200.

Specifically, the first high-temperature insulating tape 103 wraps the cathode insulating tape area 12 in a U shape or/and the second high-temperature insulating tape 104 wraps the anode insulating tape area 22 in a U shape. The first polymeric adhesive on the cathode insulating tape area 12 is used to make the first high-temperature insulating tape 103 tightly adhere to the cathode insulating tape area 12, and the second polymeric adhesive on the anode insulating tape area 22 is used to make the second high-temperature insulating tape 104 tightly adhere to the anode insulating tape area 22.

### (S5) Battery Assembly

The dry cell 10 is put into the casing 4 at a certain temperature and pressure, and the positive tab 100 and the negative tab 200 respectively serve as the cathode current collector and the anode current collector 42, respectively. Then the electrolyte is injected, and the casing 4 with the dry cell 10 is subjected to primary aging, sealing, and secondary aging to obtain the desired lithium-manganese dioxide primary battery.

In an embodiment, the graphene-based manganese dioxide is produced by coating surfaces of manganese dioxide particles with graphene nanoparticles, and the graphene-based manganese dioxide is dried at 375 to 400° C. in the vacuum drying oven before use.

In an embodiment, the metal lithium is added into an organic solvent to undergo liquid phase buoyancy dispersion, to which the carbon powder is added such that with volatilization of the organic solvent, the carbon powder settles from vaporized organic solvent to coat the metal lithium to form the lithium-carbon composite material. Before use, the lithium-carbon composite material is dried at 100-120° C. in the vacuum drying oven.

Specifically, the organic solvent is selected from the group consisting of undecane, dodecane, tridecane, tetradecane, pentadecane and a combination thereof, that is, the relative density of the organic solvent is 0.74-0.77 g/m³, while the relative density of the metallic lithium is 0.534 g/m³, so that the metal lithium is suspended in the organic solvent. The metal lithium is melted to form micro-sized lithium droplets, which are also suspended in the organic solvent. Then the above-mentioned system is subjected to high-speed stirring for centrifugal dispersion, so as to evenly disperse the micro-sized lithium droplets in the organic solvent. When the lithium droplets reaches the preset fineness, they can pass through a 400-800 mesh screen under the action of centrifugal dispersion (according to the flow principle of the substance in a liquid state, the micro-sized lithium droplets can pass through the screen by virtue of their own suspending force). Since the above processes are all carried out in a liquid organic solvent, the dispersion process is called the liquid buoyancy dispersion.

After the carbon powder is placed in the organic solvent, with the volatilization of the solvent, the carbon powder settles down from the vaporized organic solvent to coat the micro-sized lithium droplets meeting the preset fineness, so that the lithium-carbon composites material is obtained.

In an embodiment, the coating machine and the vacuum drying oven both have a vacuum internal environment with a pressure of −0.08 to −0.1 MPa; and a pressure of an external environment of the coating machine and the vacuum drying oven is standard atmospheric pressure.

In an embodiment, the aluminum mesh current collector 101 is an aluminum mesh sheet with a thickness of 10-25 μm and high porosity; and the copper mesh current collector 102 is a copper mesh sheet with a thickness of 6-20 μm and high porosity.

In an embodiment, the first conductive agent and the second conductive agent are independently selected from the group consisting of superconducting carbon black, conductive graphite, carbon fiber, carbon nanotube, graphene and a combination thereof; and the first binder and the second binder are independently selected from the group consisting of polyvinylidene fluoride, styrene butadiene rubber, sodium carboxymethyl cellulose and a combination thereof.

Referring to FIG. 4, the first high-temperature insulating tape 103 includes a first substrate 1031 and a first adhesive layer 1032, and the second high-temperature insulating tape 104 includes a second substrate and a second adhesive layer. The first substrate 1031 and the second substrate are independently selected from the group consisting of polyimide, polysulfone, polyphenylene sulfide, polyetherketone and a combination thereof. The first adhesive layer 1032 and the second adhesive layer are both silica gel. The first high-temperature insulating tape 103 and the second high-temperature insulating tape 104 both have a thickness of 10-60 μm and are capable of withstanding a temperature greater than 200° C. The first polymeric adhesive and the second polymeric adhesive are independently selected from the group consisting of PVDF, polyacrylonitrile (PAN) and a combination thereof. Specifically, the first adhesive layer 1032 and the second adhesive layer respectively wrap the cathode insulating tape area 12 and the anode insulating tape area 22 in a U shape, and the first substrate 1031 covers the first adhesive layer 1032 to isolate it from the outside, thereby protecting the first adhesive layer 1032, and the second substrate covers the second adhesive layer to isolate it from the outside, thereby protecting the second adhesive layer.

### Embodiment 1

As shown in FIG. 6, in the case of a discharge current of 3C and a temperature of −40° C., the lithium-manganese dioxide primary battery prepared herein is superior to the traditional lithium manganese primary battery in the discharge voltage plateau and the capacity retention rate.

Described above are merely preferred embodiments of the disclosure, which are not intended to limit the disclosure. It should be understood that any change, replacement and modification made by those skilled in the art without departing from the spirit of the disclosure should fall within the scope of the disclosure defined by the appended claims.

What is claimed is:

1. A lithium-manganese dioxide primary battery, comprising:
a dry cell;
an electrolyte; and
a casing;
wherein the dry cell comprises a plurality of positive plates, a plurality of negative plates and a plurality of separators; the plurality of positive plates, the plurality of negative plates and the plurality of separators are laminated in a manner of repeated “positive plate-separator-negative plate-separator”; the lithium-manganese dioxide primary battery is prepared by placement of the dry cell in the casing, injection of the electrolyte, primary aging, sealing and secondary aging; each of the plurality of positive plates is a graphene-based manganese dioxide positive plate; each of the plurality of negative plates is a lithium-carbon composite negative plate; both surfaces of each of the plurality of positive plates are provided with a positive reserved tab, respectively; both surfaces of each of the plurality of negative plates are provided with a negative reserved tab, respectively; and the lithium-manganese dioxide primary battery has a discharge capacity equal to or larger than 3C at −40° C.;
the dry cell is provided with a positive tab and a negative tab; positive reserved tabs of the plurality of positive plates are aligned with each other and welded with a first flat metal sheet current collector to form the positive tab; negative reserved tabs of the plurality of negative plates are aligned with each other and welded with a second flat metal sheet current collector to form the negative tab;
each of the plurality of ceramic separators is a nanoporous ceramic separator;
the electrolyte is made by mixing 0.7-2 mol of a lithium salt with an organic solvent, wherein the organic solvent is carbonate or carboxylate; and
the positive tab and the negative tab are respectively provided at both ends of the casing to respectively serve as a positive current collector and a negative current collector.

2. The lithium-manganese dioxide primary battery of claim 1, wherein the lithium salt is selected from the group consisting of lithium perchlorate, lithium hexafluorophosphate, lithium tetrafluoroborate, lithium bis(oxalate) borate, lithium oxalyldifluoroborate, lithium bis(fluorosulfonyl)imide, lithium (trifluoromethanesulfonyl)imide, lithium trifluoromethansulfonate and lithium iodide;
the carbonate is selected from the group consisting of dimethyl carbonate, ethyl methyl carbonate and diethyl carbonate; and
the carboxylate is selected from the group consisting of methyl formate, methyl acetate, ethyl acetate, propyl acetate, methyl propionate, methyl butyrate and ethyl butyrate.

3. The lithium-manganese dioxide primary battery of claim 1, wherein the casing is square, and is made of steel, aluminum or an aluminum-plastic material.

4. A method for preparing the lithium-manganese dioxide primary battery of claim 1, comprising:
(S1) mixing 85%-98% by weight of graphene-based manganese dioxide, 1%-10% by weight of a first conductive agent and 1%-15% by weight of a first binder to prepare a cathode active paste; evenly coating the cathode active paste on both surfaces of an aluminum mesh current collector using a coating machine to form a cathode coating, wherein a cathode blank area is reserved between four edges of the cathode coating and four edges of the aluminum mesh current collector; dividing the cathode blank area into the positive reserved tab, a cathode polymeric adhesive area and two cathode insulating tape areas, wherein the positive reserved tab and the cathode polymeric adhesive area are respectively located at both ends of the cathode coating, and the two cathode insulating tape areas are respectively located at both sides of the cathode coating; drying the aluminum mesh current collector coated with the cathode coating at 85° C. in a vacuum drying oven; calendering the cathode coating to a surface density of 50-100 mg/cm² using a calender; dipping the two cathode insulating tape areas in a first polymeric adhesive such that the two cathode insulating tape areas are covered with the first polymeric adhesive; and drying the aluminum mesh current collector coated with the cathode coating at 110° C. in the vacuum drying oven to obtain the graphene-based manganese dioxide positive plate with a moisture content of less than 30 ppb;
(S2) mixing 85%-98% by weight of a lithium-carbon composite material, 1%-10% by weight of a second conductive agent and 1%-15% by weight of a second binder to produce an anode active paste; evenly coating the anode active paste on both surfaces of a copper mesh current collector using the coating machine to form an anode coating, wherein an anode blank area is reserved between four edges of the anode coating and four edges of the copper mesh current collector; dividing the anode blank area into the negative reserved tab, an anode polymeric adhesive area and two anode insulating tape areas, wherein the negative reserved tab and the anode polymeric adhesive area are respectively located at both ends of the anode coating, and the two anode insulating tape areas are respectively located at both sides of the anode coating; drying the copper mesh current collector coated with the anode coating at 85° C. in a vacuum drying oven; calendering the anode coating to a surface density of 25-50 mg/cm² using the calender; dipping the two anode insulating tape areas in a second polymeric adhesive such that the two anode insulating tape areas are covered with the second polymeric adhesive; and drying the copper mesh current collector coated with the anode coating at 110° C. in the vacuum drying oven to obtain the lithium-carbon composite negative plate with a moisture content of less than 30 ppb;
(S3) coating front and back surfaces of an ordinary ceramic separator respectively with a nano-alumina coating followed by drying in the vacuum drying oven to remove solvent in the nano-alumina coating to obtain the nanoporous ceramic separator, wherein the nanoporous ceramic separator has a thickness of 6-40 μm, and an area of the nanoporous ceramic separator is larger than an area of the graphene-based manganese dioxide positive plate or the lithium-carbon composite negative plate;
(S4) laminating a plurality of graphene-based manganese dioxide positive plates obtained from step (S1), a plurality of lithium-carbon composite negative plates obtained from step (S2) and a plurality of nanoporous ceramic separators obtained from step (S3) in a manner of repeated “graphene-based manganese dioxide positive plate-nanoporous ceramic separator-lithium-carbon composite negative plate-nanoporous ceramic separator” to form the dry cell, wherein during the laminating process, the two cathode insulating tape areas of each of the plurality of graphene-based manganese dioxide positive plates are wrapped with a first insulating tape, and the two anode insulating tape areas of each of the plurality of lithium-carbon composite negative plates are wrapped with a second insulating tape; first reserved tabs of the plurality of graphene-based manganese dioxide positive plates are laminated, aligned with each other and welded with the first flat metal sheet current collector to form the positive tab; and second reserved tabs of the plurality of lithium-carbon composite negative plates are laminated, aligned with each other and welded with the second flat metal sheet current collector to form the negative tab; and
(S5) placing the dry cell into the casing at a preset temperature and a preset pressure, wherein the positive tab and the negative tab respectively serve as the positive current collector and the negative current collector; and injecting the electrolyte followed by primary aging, sealing and secondary aging to produce the lithium-manganese dioxide primary battery.

5. The method of claim 4, wherein the graphene-based manganese dioxide is prepared by coating surfaces of manganese dioxide particles with graphene nanoparticles; and the graphene-based manganese dioxide is dried in the vacuum drying oven at 375-400° C. before use; and
the lithium-carbon composite material is prepared through steps of: adding metal lithium to an organic solvent for liquid-phase buoyancy dispersion; and adding carbon powder to the organic solvent such that with volatilization of the organic solvent, the carbon powder settles from vaporized organic solvent to coat the metal lithium to form the lithium-carbon composite material; and the lithium-carbon composite material is dried in the vacuum drying oven at 100-120° C. before use.

6. The method of claim 4, wherein the coating machine and the vacuum drying oven both have a vacuum internal environment with a pressure of −0.08 to −0.1 MPa; and a pressure of an external environment of the coating machine and the vacuum drying oven is standard atmospheric pressure.

7. The method of claim 4, wherein the aluminum mesh current collector is an aluminum mesh sheet with a thickness of 10-25 μm; and the copper mesh current collector is a copper mesh sheet with a thickness of 6-20 μm.

8. The method of claim 4, wherein the first conductive agent and the second conductive agent are independently selected from the group consisting of superconducting carbon black, conductive graphite, carbon fiber, carbon nanotube, graphene and a combination thereof; and the first binder and the second binder are independently selected from the group consisting of polyvinylidene fluoride (PVDF), styrene butadiene rubber, sodium carboxymethyl cellulose and a combination thereof.

9. The method of claim 4, wherein the first insulating tape comprises a first substrate and a first adhesive layer; the second insulating tape comprises a second substrate and a second adhesive layer; the first substrate and the second substrate are independently selected from the group consisting of polyimide, polysulfone, polyphenylene sulfide, polyetherketone and a combination thereof; the first adhesive layer and the second adhesive layer are both silica gel; the first insulating tape and the second insulating tape both have a thickness of 10-60 μm and are capable of withstanding a temperature greater than 200° C.; and the first polymeric adhesive and the second polymeric adhesive are independently selected from the group consisting of PVDF, polyacrylonitrile (PAN) and a combination thereof.
